(19) United States
(12) Patent Application Publication
(10) Pub. No.: US 2004/0044547 A1
(43) Pub. Date: Mar. 4, 2004

(54) Database for retrieving medical studies

(75) Inventors: Michael Klennert, Bornheim (DE); Reinhard Griebenow, Bergisch Gladbach (DE); Peter Brimmers, Cologne (DE)

Correspondence Address: BANNER & WITCOFF, 1001 G STREET N W, SUITE 1100, WASHINGTON, DC, 20001, US

(73) Assignee: Academy GmbH & Co. KG, Cologne (DE)

(21) Appl. No.: 10/447,305

(22) Filed: May 29, 2003

(30) Foreign Application Priority Data
Aug. 31, 2002 (DE) DE 102 40 216.7

(51) Int. Cl. G06F 17/60; G06F 7/00; G06F 17/00

(52) U.S. Cl. 705/2; 707/104.1

(57) ABSTRACT

To allow physicians to retrieve relevant medical evidence for decision-making in determining a therapy to be used for a specific patient profile, the invention provides a method for database-based retrieval of a number of medical studies matching a specific patient profile as well as a database for implementing such a method. The results of medical studies can be classified and stored in the database for subsequent querying by a doctor to determine whether any studies match patient-specific criteria. Studies with an exclusion criterion that matches a patient-specific criterion can be screened out of the search results, and multiple studies can be output and/or displayed in such a manner that the studies can be compared against one another.

### CROSS-REFERENCE TO RELATED APPLICATIONS

This application claims priority to German patent application DE 102 40 216.7, filed Aug. 31, 2002, entitled Method and Database for Retrieving Medical Studies.

### FIELD OF THE INVENTION

The present invention, generally, is directed towards computer databases. More specifically, the present invention concerns a method and system for database-based retrieval of a set of medical studies matching a specific patient profile.

### BACKGROUND OF THE INVENTION

Today, physicians, when making decisions as to which therapy to use to treat specific patient indications and symptoms, increasingly use not only their own individual clinical expertise, but frequently attempt to gain access to third-party evidence, in particular findings of current clinical studies, in order to prevent basing their therapeutic decisions on information that is no longer current. In this context, the term “individual clinical expertise,” as referred to herein, means the know-how and judgment acquired by physicians as a result of their experience and clinical practice, whereas the term “third-party evidence” means research that is relevant from a clinical point of view, in particular basic medical research and patient-oriented research on the accuracy of diagnostic methods (including physical exams), the relevance of prognostic factors and the effectiveness and safety of therapeutic, rehabilitative, and preventive measures.

In addition to general and/or clinical physicians, social medicine specialists as well as those involved in planning and purchasing health care services and even the general public are increasingly interested in using the findings of evidence-based medicine.

At the same time, however, it is virtually impossible for physicians to have a comprehensive overview of all studies which may be relevant for their patients. While, generally speaking, the presentation of medical studies usually follows a similar structure, individual elements of this structure vary to a certain degree in terms of their presentation, designation, wording, and details, which makes it virtually impossible to specifically search all studies for data matching a patient's indications. While existing databases, e.g. those offered by the U.S. National Library of Medicine or the Cochrane Collaboration, can be searched by keywords contained in the summary/abstract, the full text or scientific comments for a medical study stored in one of the databases, as well as by bibliographic data of any of the medical studies included However, this is usually not sufficient to specify the subset of studies which may be relevant for a patient and his or her profile in such a manner that such subset remains manageable while still containing all relevant studies.

### BRIEF SUMMARY OF THE INVENTION

To overcome limitations in the prior art described above, and to overcome other limitations that will be apparent upon reading and understanding the present specification, the object of this present invention is therefore to provide a method and a database of the type alluded to above that will allow a physician to conduct a specific search of medical studies matching the indication and the profile of his or her patient.

A first aspect of the invention provides a method for database-based retrieval of a number of medical studies matching a specific patient profile. Results of a plurality of medical studies are classified, where each medical study has a group of selected participants. For each classified study information is stored in a database, based on the classification for each respective study, including inclusion criteria defining how participants are selected from a group of possible participants to be included in the study, exclusion criteria defining how possible participants are excluded from participating in the study, parameters of the group of selected study participants, and information describing the study. After the studies have been classified and stored in the database, a user can query the database by populating a search mask with patient-specific parameters in order to retrieve studies matching a specific patient profile. Upon querying the database for the patient-specific parameters, a list of one or more studies whose classification information matches at least one patient-specific parameter is generated. The patient-specific parameters can be compared to the exclusion criteria of the identified studies to remove from the list of identified studies any study whose exclusion criterion matches a patient-specific parameter.

According to another aspect of the invention, there is a system for querying medical study information. The system has a processor and a memory for storing a medical database having classification information for a plurality of medical studies, where the classification information for each study includes inclusion criteria, exclusion criteria, participant parameters, and information describing the study, and for storing computer executable instructions that, when executed, perform a method for querying the database. The method includes receiving query input comprising at least one patient-specific criterion for which the medical database should be searched, querying the database based on the query input, to identify studies whose classification information matches at least one patient-specific criterion, comparing the at least one patient-specific criterion with the exclusion criteria of each of the plurality of studies, and excluding any study with an exclusion criterion that matches an input patient-specific criterion.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a method flowchart according to an illustrative aspect of the invention.

FIG. 2 illustrates a block diagram of a data processing device according to an illustrative aspect of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

Insofar as the classification of the medical studies to be included in the database are concerned, usually, the full text of a published medical study is first analyzed by medical specialists, and any data which may be suitable for classification are extracted from the full text, then standardized, if necessary, and stored in a corresponding data section of the database in which data of one classification class are kept on file. It is the responsibility of such medical specialists to adjust the classification in a suitable manner depending on each indication/symptom as well as to standardize the data that are stored in a suitable fashion. One aspect of the classification process is the definition of inclusion and exclusion criteria according to which the study participants are selected as well as the definition of the parameters of the group of participants at the start of the study, the so-called baseline characteristics. Any conventional database technology may be used to implement the database interface to enter search criteria via a search mask.

The database may include inclusion and exclusion criteria. Including inclusion and exclusion criteria as well as baseline characteristics in the database makes it possible to use, in addition to the indication/symptom, additional individual patient parameters for search purposes. One particularity is that individual parameters are not only compared with the study parameters, but individual parameters can also automatically be used as negative characteristics to exclude, from the very outset, certain studies from the subset of studies which are relevant for the therapeutic decision-making process. As a result, studies that are available for a specific indication are presorted, and their number is significantly reduced without excluding any studies from the hit list that are actually relevant for the physician. That is, if the searched characteristic is listed as an exclusion criteria for a study, that study might not be returned with any search results.

As a result, an advantage of the method in accordance with this present invention and of the corresponding database is that they permit the correlation of a specific patient profile with abstract medical data contained in medical-scientific studies; such correlation is performed by the database, and the database user is provided with a clearly defined search result.

Depending on which data is of particular interest to users, the database can be programmed in such a manner so that at least one piece of information from one of the studies can be retrieved wherein the patient parameters match the inclusion criteria of the study, i.e. where the patient would have been included in the group of study participants in case such patient had been available for the corresponding study.

In addition, it is possible to store additional data on the subgroups of the participant group of the study in the database in the event that the studies yielded, for certain participants of a group with special characteristics, a study result which is different from that for the other participants. When the baseline characteristics of these subgroups match the patient parameters entered into the search mask, information on the associated studies may be displayed even when the specified patient profile does not match all inclusion criteria.

It is additionally possible that at least one piece of information regarding one of the studies is retrieved when all patient parameters match the parameters of the participant group, even when the patient parameters fail to match all inclusion parameters.

Finally, the method may also be performed in such a manner that no studies are displayed when the patient parameters fail to fully match the inclusion criteria or the parameters of the participant group.

To provide users, in particular physicians in charge of treatment, with a proper overview over the applicability of the matching studies, the studies are preferably categorized prior to display to the user. In an illustrative embodiment, a subset or superset of the following categories may be used:

a. studies in which the patient criteria match all inclusion criteria and all criteria of at least one participant,

b. studies in which the patient criteria match all inclusion criteria,

c. studies in which the patient criteria do not match all inclusion criteria, but all criteria of a participant,

d. studies in which the patient criteria fail to match either all inclusion criteria or all criteria of a participant,

e. studies in which the patient criteria do not match any inclusion criteria nor any criteria of a participant, and/or

f. studies in which the patient criteria match at least one exclusion criterion.

Even studies in which the patient criteria match at least one exclusion criterion and, accordingly, are not relevant for the selection of a suitable therapy may be relevant to users because studies frequently specify why a specific exclusion criterion was defined as such, providing users, in particular physicians in charge of treatment, with valuable additional information.

In an illustrative embodiment of the invention, the database includes data on the title, source, summary/abstract, background of the study, definition of the study, design of the study, study protocol(s), study end points, statistical method(s) used, any complications encountered by the participants over the course of the study, study results and/or the complete content of the published study and/or scientific comments thereon. Each of the above items may also be classified by assigning them to a corresponding classification in the database.

According to an aspect of the invention, the database may also include data on the quality levels of the studies, the forms of therapy used as well as any substances and/or groups of substances studied and make it possible to search for these criteria via the search mask. In this context, the term “quality level” means in particular the classification of studies defined in “Evidence Based Medicine”, David L. Sackend, 2nd Edition, Churchill Livingston, 2000 and internationally accepted under the term “level of evidence”; the term “form of therapy” refers to whether the study participant was treated by means of medication and/or invasive procedures.

In addition, the inclusion criteria and/or participant criteria stored in the database may include specific criteria such as indication, subindication, and/or the degree of severity of the indications and may be correlated with corresponding patient parameter entries. In addition, the group parameters may include data on age, sex, race, accompanying diseases, existing medication, and/or any invasive procedures for the participants. In both cases, it is meaningful to make it possible to enter patient parameters which match the specific information and criteria into the search mask.

Preferably, as end points, the database includes in particular study data on the mortality rate, hospitalization, rehospitalization, and/or any invasive procedures that may be necessary upon completion of therapy, to ensure that such information is immediately available whenever study data is displayed to a user, independently from the full text of the study. Such data may be particularly interesting in the case of cardiological indications, e.g. data on cardiac insufficiency or coronary heart diseases.

Individual parts of several studies to be retrieved or entire studies can be retrieved either sequentially or simultaneously. Retrieving them simultaneously is advantageous insofar as matching segments of two or several studies can be compared with each other directly, i.e., by showing inclusion parameters, participant parameters and data of the studies retrieved side by side.

In addition, in order to help physicians, the database(s) may include comparative comments and/or graphics for two or more studies, which, when the studies for which comments are provided are shown side by side, may be displayed as additional information.

The database may also include information regarding which of the studies can be compared with each other. As a result, studies that are comparable to a specific study can be displayed as a subset, regardless of whether the specific patient parameters match the inclusion or exclusion parameters or the baseline characteristics.

To illustrate further details of the present invention, the following provides a description of the structure and operation of a preferred database in accordance with an illustrative embodiment of the invention.

A suitable database may be created by first subjecting studies, which are typically available in a full-text version including illustrations, to a classification scheme. The full-text version is converted into keywords as well as, insofar as the study design is concerned, graphics, although without modifying the content of the findings of the study.

According to an illustrative aspect of the invention, the database may classify information based on title/source, background, design, inclusion criteria, exclusion criteria, protocol, statistical methods used, participant group parameters (baseline characteristics), complications, end points, definitions, results, and/or summary/abstract. Other classifications may also or alternatively be used.

The class “Title/Source” may include a part or all relevant bibliographic data of the studies included; the class “Summary/Abstract” may include a summary or abstract contained in a study or prepared by a third party. The class “Background” may include keywords regarding the underlying issues to be-addressed in the respective studies, including with respect to any prior studies, if necessary, and the class “Design” may include keywords on the planned stages of the study, e.g. specifying the medication as well as, if applicable, the objectives of the studies.

“Inclusion criteria” may include all criteria to be met by a study participant to be included in the group of study participants; the term “exclusion criteria” may include all criteria which would exclude a study participant from the group of study participants.

The classes “Protocol” and “Statistical Methods” may include information on how the progress of the study was monitored and documented as well as any results obtained and information on how the results were evaluated.

The term “Participant Group Parameters”, i.e. the so-called baseline characteristics, may include all data describing the study participants of the group at the beginning of the study, e.g. data on age, sex, race, risk factors, subindications, existing medication, any interventions performed (invasive procedures), etc. as well as any data ranges resulting therefrom. The data of all study participants included in the study results may be included.

The class “definitions” may include information on which terms are used synonymously in different studies, or how specific terms have been defined.

Finally, the classes “Complications”, “End Points”, and “Results” may include data on the progress of the study, e.g., “complications” such as side effects encountered by some or all study participants, necessary invasive or other procedures or the like, the end points of the development in the study participants, e.g. restitution, hospitalization and/or rehospitalization, or death, and the result of the studies, e.g. in the form of a statistical analysis of the progress of therapy observed and end points. Any data obtained through analyzing subgroups of a participant group of a study may also be assigned to these classes. In this case, it may be advantageous to specifically mark those baseline characteristics which are characteristic for the subgroup or to store an additional parameter combination as baseline characteristics for such a subgroup.

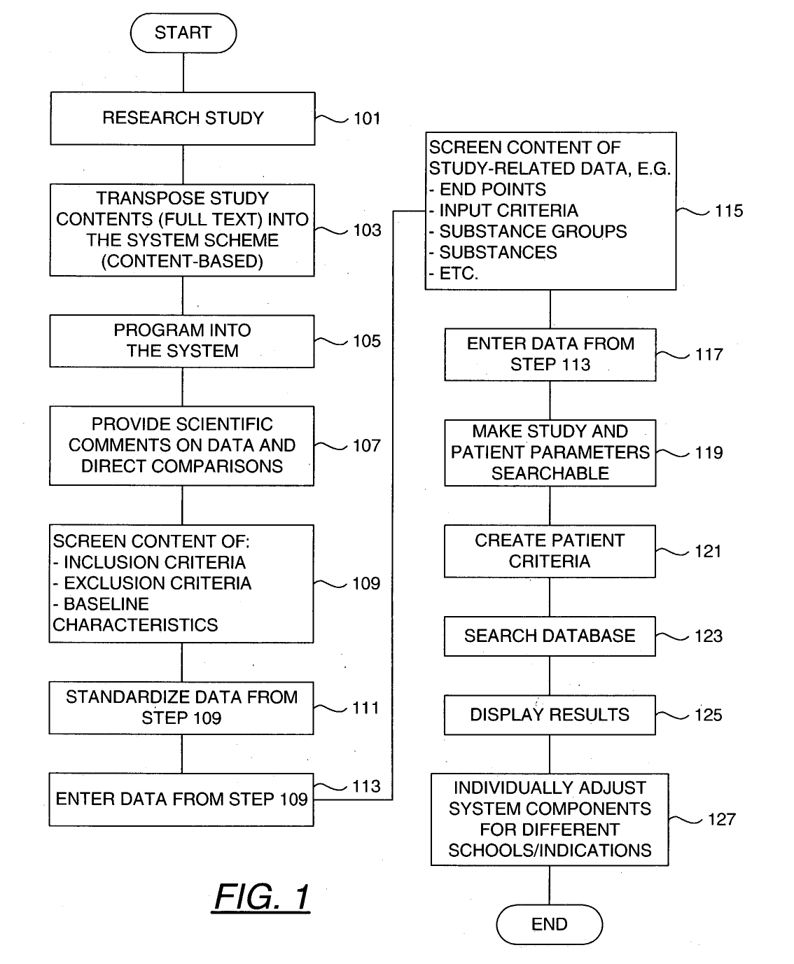

FIG. 1 illustrates a method for analyzing a full-text version of a study in order to extract specific data and enter them in a database according to an illustrative aspect of the invention. Initially, in step 101, one or more studies are performed.

Depending on the planned size of the database, a database may be limited to studies regarding a single indication or medical problem, or may contain studies regarding many different indications and medical problems. In the former case, the indication or medical problem may be considered to be known, as a result of which such information may not necessarily need to be entered when data are entered in the database. In the latter case, a separate class has been defined to enter the indication for which research has been conducted within the scope of a study. However, it is also possible to define the indication as an inclusion criterion.

The selection of these classes in and by itself is significant since it makes it possible to standardize all findings and criteria of medical studies within the scope of a classification scheme.

In steps 103-105, the full text of the study is classified and imported into the database using a classification scheme as described above. In step 107, scientific comments on data and direct comparison information between studies may be entered into the database.

In step 109, the data extracted from the full-text version of the study and assigned to the classes Inclusion Criteria, Exclusion Criteria, and Baseline Characteristics are screened to determine whether they can be standardized in step 111 and then stored in the database in step 113, in standardized form if applicable, together with the other “classified” data. Since these steps require experience in terms of analysis of medical studies, standardization is preferably carried out by competent medical experts.

In step 115, study-related data is screened and, in step 117, the screened data is entered into the database. Once the relevant study data has been screened and entered, the study data is now searchable in step 119.

In addition to providing indication information for the database search in step 121, users of the database may optionally enter additional parameters that are suitable to describe the patient, such as data on age, sex, race, accompanying diseases, risk factors, existing medication, any procedures performed, etc. in the search mask. Additionally, users can also enter additional search criteria in the search mask, such as the quality level, form of therapy, substances or groups of substances studied, or other data that are being stored in the database. Such data may also include information on study sponsors, in case such data are stored in the database. The search mask may include an entry aid which limits possible entries to criteria which are included in the inclusion and exclusion criteria as well as the baseline characteristics.

Once the patient profile has been entered for searching purposes, the database is searched in step 123 and the results are displayed in step 125. The results may be displayed in any manner. However, according to an illustrative embodiment, the studies may be grouped for display by the following categories:

excluded,

included,

not included, not excluded, but included under the baseline characteristics and analyzed as a subgroup,

not included, not excluded, but included under the baseline characteristics, no subgroup analysis,

not included, not excluded, no further data available.

In this context, “excluded” refers to studies wherein at least one of the parameters describing the patient profile matches an exclusion criterion of the study, and “included” refers to studies wherein the patient parameters describing the patient profile match the inclusion criteria or at least do not contradict the same. In addition, “included under the baseline characteristics” means that the parameters of the patient profile that have been entered do not contradict any of the baseline characteristics and match at least one of the baseline characteristics.

The studies making up the different groups can either be grouped, which is preferred, or displayed after sorting them by different criteria. Categorization may be useful by ranking the studies that have been found by order of importance in terms of their applicability.

The studies may alternatively be displayed sequentially, e.g. on a screen, and it is also possible to display not the whole content of a study stored in a database, but only a particularly interesting section thereof, as determined by the user. It is also possible to directly compare two or more studies side by side or one on top of one another, and once again, particularly interesting sections can be compared. In this context, any comments comparing the studies may also be displayed.

In addition, as referred to above, the database may include information as to which studies can be compared to one another. This allows the user to display all comparable studies regardless of whether such studies are applicable to a specific patient profile or not, as applicable.

The system described above not only makes it possible to match patient profile information with the profile of study participants by specifying the indication or subindication, e.g. cardiac insufficiency, restrictive criteria such as the degree of severity (as long as such can be defined), definable clinical situations, etc. to find studies that are relevant based on the patient profile, but also allows users to include other aspects in their search, such as accessing important patient-related study data, e.g. study end points such as death, rehospitalization, intervention, etc.

At a later point in time, when data sets are largely complete, this may make it possible to match every individual clinical patient situation with a corresponding situation of a study participant or a group of study participants.

The study and patient criteria may need to be adjusted for each indication and medical specialty. For example, the relevance of patient and study parameters in the field of oncology frequently differ significantly from that of cardiological parameters. One of the factors which contributes to the scientific quality of the database is that, as a basic rule, these criteria are readjusted and standardized for each indication.

The technical quality of the database, on the other hand, is guaranteed by the fact that the basic structure of the class system permits such an adjustment. The output parameters and the categorization related therewith, however, can remain the same.

The above-described database can provide treating physicians with a tool to quickly access medical evidence that is relevant for their patients and use such evidence in their decision-making processes. In the past, this was impossible for many indications.

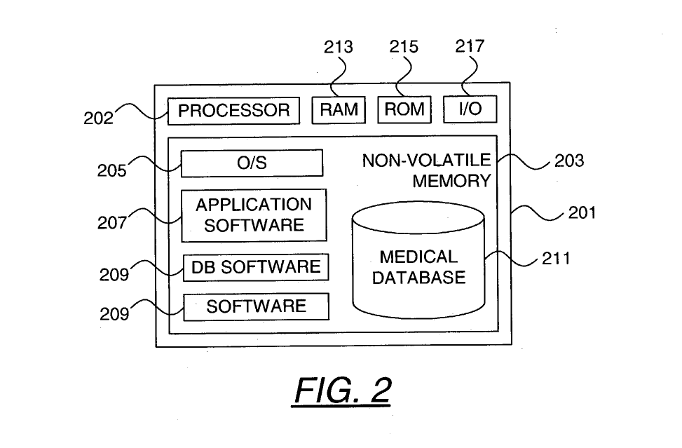

With reference to FIG. 2, one or more aspects of the invention may be embodied in computer-executable instructions embodied in one or more program modules 205, 207, 209 and/or databases 211 stored in a memory 203, executed by one or more processors 202 in one or more data processing devices 201. Generally, program modules may include routines, programs, objects, components, data structures, etc. that perform particular tasks or implement particular abstract data types when executed by a processor 202 in a computer 201. The computer executable instructions may be stored on a computer readable medium such as a hard disk 203, optical disk, removable storage media, solid state memory, RAM, etc. As will be appreciated by one of skill in the art, the functionality of the program modules may be combined or distributed as desired in various embodiments, and computer 201 may include additional elements as are known in the art, such as RAM 213, ROM 215, I/O 217, and the like.

While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

What is claimed is:

1. A method for database-based retrieval of a number of medical studies matching a specific patient profile, comprising:
a. classifying the results of a plurality of medical studies, wherein each medical study has a group of selected participants;
b. for each study classified in step (a), storing in a database at least the following information, based on the classification for each respective study:
i. inclusion criteria defining how participants are selected from a group of possible participants to be included in the study,
ii. exclusion criteria defining how possible participants are excluded from participating in the study,
iii. parameters of the group of selected study participants, and
iv. information describing the study,
c. populating a search mask with patient-specific parameters in order to retrieve studies matching a specific patient profile;
d. querying the database for the patient-specific parameters to identify a list of one or more studies whose classification information matches at least one patient-specific parameter; and
e. comparing the patient-specific parameters to exclusion criteria of the identified studies, and removing from the list of identified studies any study whose exclusion criterion matches a patient-specific parameter.

2. The method in accordance with claim 1, further comprising storing in the database information related to a subgroup analysis of at least one study, and
wherein step (d.) comprises querying parameters of the subgroup for the patient parameters.

3. The method in accordance with claim 1, wherein step (d.) comprises querying the database for the patient-specific parameters to identify studies whose classification information matches all of the patient-specific parameters.

4. The method in accordance with claim 1, further comprising excluding any study when the patient-specific parameters fail to fully match either the inclusion criteria or the parameters of the participant group.

5. The method in accordance with claim 1, further comprising categorizing the list of studies resulting after step (d.), and outputting the categorized list of identified studies.

6. The method in accordance with claim 5, wherein a first category comprises all studies in which the patient-specific parameters match all inclusion criteria and all criteria of at least one participant of the study.

7. The method in accordance with claim 5, wherein a first category comprises all studies in which the patient-specific parameters match all inclusion criteria of the study.

8. The method in accordance with claim 5, wherein a first category comprises all studies in which the patient-specific parameters do not match all inclusion criteria, but do match all criteria of a participant of the study.

9. The method in accordance with claim 5, wherein a first category comprises all studies in which the patient-specific parameters fail to match either all inclusion criteria of the study or all criteria of a participant of the study.

10. The method in accordance with claim 5, wherein a first category comprises all studies in which the patient-specific parameters do not match any inclusion criteria nor any criteria of a participant.

11. The method in accordance with claim 5, wherein a first category comprises all studies in which the patient-specific parameters match at least one exclusion criterion.

12. The method in accordance with claim 1, wherein the information describing each study comprises a title, source, and summary of the study.

13. The method in accordance with claim 1, wherein the information describing each study comprises a background of the study and a definition of the study.

14. The method in accordance with claim 1, wherein the information describing each study comprises a design of the study.

15. The method in accordance with claim 14, wherein the design of the study comprises a study protocol, study endpoints, and a statistical method used.

16. The method in accordance with claim 1, wherein the information describing each study comprises complications encountered by participants of each study.

17. The method in accordance with claim 1, wherein the information describing each study comprises study results.

18. The method in accordance with claim 1, wherein the information describing each study comprises a copy of the published study.

19. The method in accordance with claim 1, wherein the information describing each study comprises scientific comments regarding the study.

20. The method in accordance with claim 1, wherein inclusion criteria comprises a specific criteria Indication, Subindication, and degree of indication severity.

21. The method in accordance with claim 1, wherein the parameters of the group of selected study participants comprises age, sex, race, accompanying diseases, existing medication and any invasive procedures that have been performed.

22. The method in accordance with claim 1, wherein the database includes data on a quality level of each study.

23. The method in accordance with claim 1, wherein the database includes data on a form of therapy used for each study.

24. The method in accordance with claim 1, wherein the database includes data on a substance being studied for at least one study.

25. The method in accordance with claim 15, wherein the study end point data comprises an indication of death, hospitalization, rehospitalization, or invasive procedures.

26. The method in accordance with claim 1, wherein the search mask used to query the database in step d. comprises a quality level, a form of therapy, a specific substance being studied, and a specific end point.

27. The method in accordance with claim 1, further comprising outputting at least two studies for comparison to one another.

28. The method in accordance with claim 27, wherein the comparison includes comments and graphics comparing the studies.

29. The method in accordance with claim 1, wherein the database includes data indicating which studies can be compared with each other.

30. A system for querying medical study information, comprising:
a processor;
memory for storing a medical database having classification information for a plurality of medical studies, wherein the classification information for each study includes inclusion criteria, exclusion criteria, participant parameters, and information describing the study, and for storing computer executable instructions that, when executed, perform a method comprising:
a) receiving query input comprising at least one patient-specific criterion for which the medical database should be searched;
b) querying the database based on the query input, to identify studies whose classification information matches at least one patient-specific criterion; and
c) comparing the at least one patient-specific criterion with the exclusion criteria of each of the plurality of studies, and excluding any study with an exclusion criterion that matches an input patient-specific criterion.

31. The system of claim 30, wherein the computer executable instructions further comprise:
d) outputting information from the set of studies identified in steps b)-c).

32. The system of claim 30, wherein the database further stores information related to a subgroup analysis of at least one study, and
wherein step b) comprises querying parameters of the subgroup for the patient-specific parameters.

33. The system of claim 30, wherein step b) comprises querying the database for the at least one patient-specific criterion to identify studies whose patient-specific parameters matches all of the at least one patient-specific criterion.

34. The system of claim 31, wherein the computer executable instructions further comprising categorizing the output studies.

35. The system of claim 30, wherein inclusion criteria comprise a specific criteria indication, subindication, and degree of indication severity.

36. The system of claim 30, wherein the parameters of the group of selected study participants comprises age, sex, race, accompanying diseases, existing medication and any invasive procedures that have been performed.

37. The system of claim 30, wherein the database includes data on a form of therapy used for each study.

38. The system of claim 30, wherein the database includes data on a substance being studied for at least one study.

39. The system of claim 31, wherein step c) further comprise displaying at least two studies in comparison to one another.
